(19) United States
(12) Patent Application Publication
(10) Pub. No.: US 2022/0005078 A1
(43) Pub. Date: Jan. 6, 2022

(54) SYSTEM AND METHOD FOR EXECUTING REWARDING OF USER ACTIVITY AND ADVERTISEMENT TRANSACTIONS IN SOCIAL NETWORKING SERVICE

(71) Applicant: COMMON COMPUTER INC., Seoul (KR)

(72) Inventors: Minhyun KIM, Seoul (KR); Dongil SEO, Seoul (KR); Seonghwa YUN, Gyeonggi-do (KR); Youngseo YOO, Seoul (KR)

(21) Appl. No.: 17/293,887

(22) PCT Filed: Nov. 14, 2019
(86) PCT No.: PCT/KR2019/015590

§ 371 Date: May 13, 2021

(30) Foreign Application Priority Data
Nov. 14, 2018 (KR) 10-2018-0140018
Nov. 14, 2019 (KR) 10-2019-0146242

(51) Int. Cl. G06Q 30/02; G06Q 50/00; G06Q 20/38

(52) U.S. Cl. CPC G06Q 30/0273; G06Q 30/0276; G06Q 20/389; G06Q 50/01

(57) ABSTRACT

The present disclosure provides a method and a system for executing activity reward and advertisement transactions in an internet-based social networking service. The method includes transmitting, by a terminal of a first user, at least a portion of coins owned by the first user to a terminal of a second user in order to acquire a share of the second user; providing, by the terminal of the second user, the share to the first user according to a ratio of the funding amount transmitted by the first user with respect to a total funding amount received by the second user, and providing, by the terminal of the second user, at least a portion of activity reward given to the second user according to a share rate owned by the first user with respect to the second user.

### CROSS-REFERENCE TO RELATED APPLICATIONS

This application claims priority under 35 U.S.C § 119 to Korean Patent Application Nos. 10-2019-0146242 and 10-2018-0140018, filed in the Korean Intellectual Property Office on Nov. 14, 2019 and Nov. 14, 2018, respectively, the entire contents of which are hereby incorporated by reference.

### TECHNICAL FIELD

The present disclosure relates to a system and a method for executing user activity reward and advertisement transactions in a social networking service, and more particularly, to a system and a method for providing rewards for various activities of the users and also transacting advertisements in a P2P manner in an internet-based or blockchain-based social networking service.

### BACKGROUND ART

In general, a social networking service (SNS) refers to an online platform that provides functions related to communication between users through message sharing, sharing of information such as various contents, and sharing and expansion of personal connections, thus allowing users to create and expand social relationships on the internet. In the SNS, the social relationships created in this way can be further strengthened as the content generated by users is shared and distributed.

In the SNS, various users can be classified according to the characteristics of the content generated by users and the activity tendency of the users, and the information and classification on the activity characteristics of the users can be managed and identified in a database. Accordingly, companies that operate SNS or companies that sell other products/services are pursuing profits through advertisements, marketing, sales of social games or items, and the like based on databases managed by SNS. However, since the existing SNS requires a system or a third party that acts as an intermediary between the subjects who want to execute sales of content or advertisements and the subjects who use the same, there is a problem in that additional costs may be incurred for content transactions, advertisements, or the like, and the profits are not distributed reasonably between sellers and purchasers.

Meanwhile, a blockchain technology is a technology that records and stores transactions performed over network communications in a reliable and safe way. A blockchain network is a system in a distributed environment in which the exchanges of digitized assets or transactions are enabled, and using a shared ledger, it records the history of electronic transactions that occur in the peer-to-peer (P2P) network. The blockchain networks use a decentralized or distributed consensus mechanism. In particular, all validating nodes on the network approve (or disapprove) the transactions by executing the same (or agreed upon) consensus algorithm on the same transaction. Since the blockchain P2P network uses such a decentralized structure and consensus algorithm, forgery and alteration of transactions by a third party is virtually impossible, and the reliability and transparency of transactions can be guaranteed.

### SUMMARY

As described above, the existing SNS enables the distribution and advertisement of contents based on the activity characteristics or the like of users. However, since the existing SNS requires a system or a third party that acts as an intermediary between the subjects who want to execute sales of content or advertisements and the subjects who use the same, there is a problem in that additional costs may be incurred for advertisements, or the like, and the profits are not distributed reasonably between sellers and purchasers. Accordingly, there is a need to provide a system and a service capable of overcoming the problems of existing SNS and executing activity reward and advertisement transactions in an efficient and rational manner.

An object of the embodiments disclosed herein is to provide a system and a method that allows transaction parties to conduct activity reward and advertisement transactions without a third party intervention, by executing the activity reward and advertisement transactions in SNS in a P2P manner. Another object of the embodiments of the present disclosure is to provide an SNS-based system that enables the reliability of transactions and rational distribution of transaction profits, by executing transactions of content and advertisements created in SNS in a blockchain-based system. Embodiments of the present disclosure may utilize the advantages of such a blockchain-based decentralized system, but the system or method of the present disclosure is not limited to being implemented on the blockchain-based system, and may be implemented in a variety of other distributed systems, at least partially centralized systems, or centralized systems.

A method for executing activity reward and advertisement transactions in a social networking service according to an embodiment of the present disclosure includes: transmitting, by a terminal of a first user, at least a portion of coins owned by the first user to a terminal of a second user in order to acquire a share of the second user, providing, by the terminal of the second user, the share to the first user according to a ratio of the funding amount transmitted by the first user with respect to a total funding amount received by the second user, and providing, by the terminal of the second user, at least a portion of activity reward given to the second user according to a share rate owned by the first user with respect to the second user.

A system for executing activity reward and advertisement transactions in a social networking service according to another embodiment of the present disclosure includes a reserve rate calculation unit that calculates a reserve rate of a funding amount exchanged between users of the social networking service to prepare a reserve pool for a payment of activity reward of users of the social networking service, a share rate calculation unit that calculates a share rate which is a ratio of the funding amount transmitted by other users with respect to a total funding amount funded to one of the users, and a reward setting unit that sets the activity reward according to the share rate or the activities of the users.

A method for transacting advertisements in a social networking service according to another embodiment of the present disclosure includes creating, by a terminal of a first user, advertisement content, presenting, by the terminal of the first user, an advertisement posting proposal and an advertisement price through a profile of a second user, determining, by a terminal of a second user, whether or not to accept the advertisement content and the advertisement price proposed by the first user, paying, by the terminal of the first user, the proposed price to the terminal of the second user when the advertisement content and the advertisement price are accepted by the terminal of the second user, and posting, by the terminal of the first user, the advertisement content through a profile of the first user.

According to various embodiments of the present disclosure, since activity reward and advertisement transactions of the users are executed in a P2P manner in the SNS, the transaction parties can perform the activity reward and the advertisement transactions without requiring an intervention of a third party. In addition, according to the embodiments of the present disclosure, in SNS, the activity reward and the advertisement transactions of the users are executed in a system based on blockchain cryptocurrency, so that the reliability of transactions and the rational distribution of transaction profits can be achieved.

The effects of the present disclosure are not limited to the effects described above, and other effects that are not mentioned above can be clearly understood to those skilled in the art based on the description provided below.

### BRIEF DESCRIPTION OF THE DRAWINGS

Embodiments of the present disclosure will be described with reference to the accompanying drawings described below, where similar reference numerals indicate similar elements, but embodiments are not limited thereto.

FIG. 1 is a schematic diagram illustrating a system for executing user activity reward and advertisement transactions in an internet-based social networking service according to an embodiment of the present disclosure.

FIG. 2 is a diagram illustrating a detailed configuration between a user terminal and a connected coin management server, according to an embodiment of the present disclosure.

FIG. 3 is a diagram illustrating a user interface of an application executing a social network service according to an embodiment of the present disclosure.

FIGS. 4A to 4C are diagrams illustrating a funding and share acquisition process executed among users in a social networking service according to an embodiment of the present disclosure.

FIG. 5 is a diagram illustrating a procedure of executing activity reward distribution among users in a social networking service according to an embodiment of the present disclosure.

FIG. 6 is a flowchart illustrating a procedure of proposing advertisement postings for a profile of a user and accepting the same in a social networking service according to an embodiment of the present disclosure.

FIGS. 7A to 7I are diagrams illustrating a user interface of an application showing a procedure of proposing advertisement postings for a profile of a user and accepting the same in a social networking service according to an embodiment of the present disclosure.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding elements may be omitted. However, even if descriptions of elements are omitted, it is not intended that such elements are not included in any embodiment.

In the present disclosure, a “social networking service” or “SNS” may refer to an online platform that provides functions related to communication between users through message sharing, sharing of information such as various contents, and sharing and expansion of personal connections, thus allowing users to create and expand social relationships on the internet. In the present disclosure, by way of example, “SNS” is described as being executed through an application or an app installed on a portable computer such as a smart phone, a tablet PC, and the like, but the execution environment of the SNS is not limited thereto, and it may include various types of programs that are executed on a personal computer such as a desktop PC, a laptop PC, or the like, a terminal for a smart home system, or an entertainment system. In the following detailed description of the embodiments of the present disclosure, a user who uses SNS and a user terminal used by the user may be used interchangeably.

In the present disclosure, “coin”, “virtual money” or “crypto-currency” may refer to a currency that can be traded on a blockchain-based platform, a payment method, or a funding method, but not limited thereto. For example, “coin” or “virtual currency” may mean a currency, a payment or funding means that can be traded in an e-commerce system, an online shopping system, an online banking system, and the like.

In the present disclosure, the term “funding” or “investment” may refer to an act of any user who is interested in the content production activities or the like of another user on the SNS and makes payment or settlement with some of his or her coins. The user who executed the funding may own a share by which he or she can acquire a certain proportion of the profits generated by the funded user's content production activities, and the like. In addition, the user who received the funding may have to provide a funding donor with a share according to a ratio of that funding with respect to the total funding amount he or she received, and may pay some of the profits generated by the content production activities and the like to the owner of the share according to the share rate.

In the present disclosure, “blockchain” is a distributed environment in which the exchanges of digitized assets and transactions are enabled through a network, and it may refer to a system capable of recording the history of electronic transactions generated in a peer-to-peer (P2P) network using a shared ledger. In this disclosure, the “blockchain” may refer to a public blockchain, such as Bitcoin, Ethereum, EOS, and the like, in which participating nodes can access the transactions of the ledger without limitation, or a private blockchain in which only the nodes authorized by an authentication node or a management node for participation can access the transactions of the ledger, but is not limited thereto, and may refer to a hybrid blockchain that combines the public blockchain and the private blockchain.

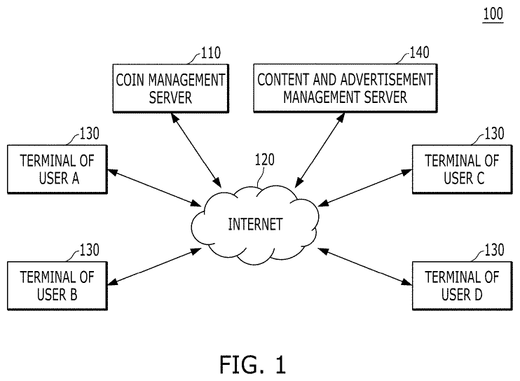

FIG. 1 is a schematic diagram illustrating a system 100 for rewarding user activities and trading advertisements in an internet-based social networking service (SNS) according to an embodiment of the present disclosure. As illustrated, the system 100 for rewarding user activities and trading advertisements (“system 100”) according to the present disclosure may include a coin management server 110 and a plurality of user terminals 130 connected through an internet 120. In addition, the system 100 may further include a content and advertisement management server 140 for relaying and managing content and advertisements created by the user terminal 130.

In FIG. 1, the coin management server 110 and the content and advertisement management server 140 are each illustrated as separate components that are separately installed, but are not limited thereto. For example, the coin management server 110 and the content and advertisement management server 140 may be installed or implemented by being integrated into one computing device. In another example, in a blockchain-based distributed computing environment, some of its functions may be installed or implemented in a distributed manner in the distributed computing devices.

In the system 100 for rewarding user activities and trading advertisements according to the present disclosure, the user terminal 130 may execute an application (or an app, hereinafter referred to as “SNS app”) that provides an SNS, thereby executing the activity reward and the advertisement transactions with other user terminals 130. In addition, the user terminals 130 may provide rewards for activities of users and execute advertisement transactions using virtual currency or coins managed and maintained by the coin management server 110 as a means of payment.

The user may sign up for membership through the SNS app installed on the user terminal 130. When the user signs up for membership through the SNS app, after performing user authentication (e.g., user authentication through inputting a mobile phone number), a certain amount of coins may be paid from the coin management server 110. For example, 1,000 coins may be paid to a user who signs up for membership for the first time, and recorded in a user profile or virtual account.

In this example, the coin may be a cryptocurrency implemented to satisfy the protocol or interface of the blockchain. For example, the coin can be implemented to satisfy the interface of the Ethereum Request for Comments (ERC) 20 token of the Ethereum platform. In this case, the coin may be traded on a blockchain-based cryptocurrency exchange, converted into another Ethereum-based token or coin, or converted into official currency of other institutions and converted into cash. In addition, as described in detail below, when the user's activity increases through content creation and transactions, additional coins may be paid in proportion to the amount of activity through a blockchain-based air-drop method.

In the present disclosure, for convenience of explanation, a user who donated or funded the coin to a specific user may be referred to as a “fan”, and the coin distributed for activity reward and advertisement transactions may be referred to as a “fancoin”. In addition, a user who creates content may be referred to as a “creator”, and a user with a high activity profit or funding amount may be referred to as an “influencer” or a “power creator”.

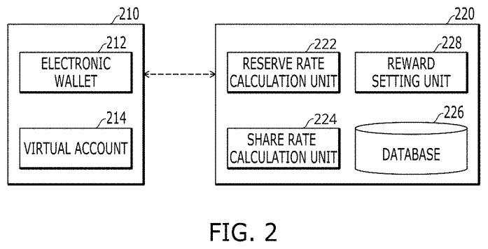

FIG. 2 is a diagram illustrating a detailed configuration of the user terminal and the connected coin management server according to an embodiment of the present disclosure. The user terminal 210 may include an electronic wallet 212, which is an electronic payment system implemented on the user terminal 210 to safely use the fancoin. In addition, the user terminal 210 may further include a virtual account 214 for storing and managing SNS subscription or member information of the user.

Although FIG. 2 illustrates that the electronic wallet 212 and the virtual account 214 are implemented separately, depending on a specific implementation method used, the electronic wallet 212 may be included in the virtual account 214. In addition, the electronic wallet 212 and the virtual account 214 may be implemented as a software component that is an SNS app installed in the user terminal 210 or may be stored or implemented in a secure memory or secure hardware of the user terminal 210.

In an embodiment, the SNS app running on the user terminal 210 may be connected to the coin management server 220 to execute payment and receipt of fancoins for content and advertisement transactions with other user terminals, investment or funding of fancoins for other user terminals, and the like.

As illustrated, the coin management server 220 may include a reserve rate calculation unit 222, a share rate calculation unit 224, a reward setting unit 226, and a database 228. For example, the reserve rate calculation unit 222 may calculate the reserve rate for excluding a certain proportion of the funding amount in the form of a reserve pool for the purpose of rewarding for the activities of users when the funding amount provided from the user terminal 210 is paid to an investment target (i.e., another user terminal) as a funding receipt amount. The remaining amount of the funding amount, excluding a certain proportion of the amount, is paid to the investment target as the funding receipt amount, and the certain proportion of the amount may be stored in the form of a reserve pool for the purpose of rewarding for the activities of users. In an embodiment, the reserve rate calculated by the reserve rate calculation unit 222 may be set fixedly (e.g., 30%), or may be set flexibly to be varied according to other objective indicators.

For example, when the user terminal 210 as the fan pays the funding amount to a specific user terminal as the creator through an SNS app, the share rate calculation unit 224 may calculate a share rate at which the fan will acquire his or her share of future activity reward with respect to the user terminal that received the funding amount. In an embodiment, the share rate calculation unit 224 may calculate the share rate by calculating a ratio of the funding amount paid by the fan with respect to the total funding amount received by the creator to date. In addition, the share rate calculation unit 224 may automatically calculate the share rate again later, since the total funding amount for the funding target changes when another user additionally funds the creator.

The reward setting unit 226 may set a reward for the activities of users who are creators, which may be paid from the reserve pool that is an amount from which the funding amount is deducted. In an embodiment, the reward setting unit 226 may set rewards for various activities of SNS users (e.g., evaluation activities for content of other users, content production activities, and the like) as an indirect activity reward according to a predetermined activity reward system, or activity reward rules. In addition, the reward setting unit 226 may allocate a certain ratios of activity reward to the fans according to the shares owned by the fans, from the activity reward obtained by adding the indirect activity reward by the activity reward system of the user and the direct activity reward such as product and content sales revenue, advertising fees received from P2P advertisers, or donations from other users.

The database 228 may store virtual account information for each user who uses the SNS in association with asset status information (e.g., reserve rate, share rate, reward setting, and the like) of the user. In addition, the database 228 may store coin transactions such as the reserve pool, payment of activity reward to users, distribution of activity profits according to share rates, and the like. In an embodiment, the coin transactions may be stored as a transaction on the blockchain, but is not limited thereto.

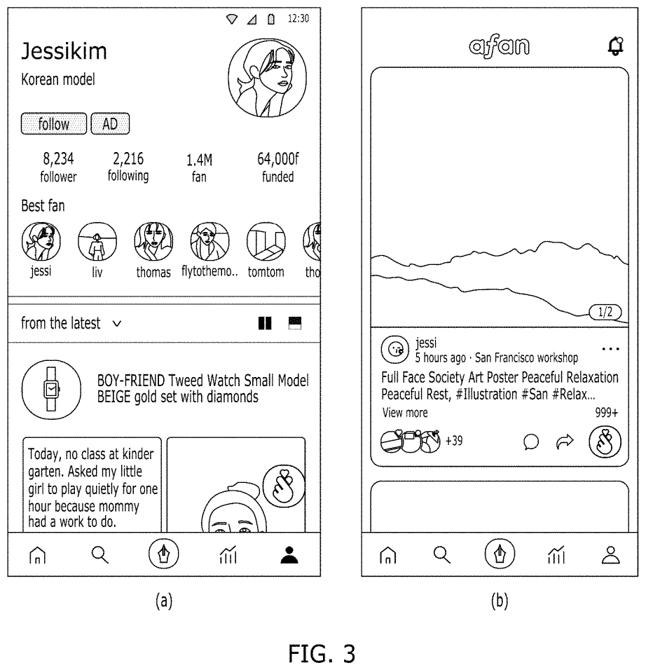

FIG. 3 is a diagram illustrating a user interface of an application (or app) executing a social network service according to an embodiment of the present disclosure.

As illustrated in of FIG. 3A, user information such as a name (e.g., “Jessikim”) and a profile picture of the user, a following button (e.g., “following” button), and an advertisement button (e.g., “AD” button) may be displayed on a profile screen of the user of the SNS app. In addition, the number of followers (e.g., follower=8,234), the number of followings (e.g., following=2,216), the number of funding entities (e.g., the number of “fan”=1.4M), and the amount of coins owned (e.g. fancoins=64,000) may be displayed together on the screen of the SNS app. In addition, a list of top funding entities (e.g., “best fans”) among the funding entities, determined in consideration of the number of followers, the number of followings, funding amount, and so on, may be displayed on the screen of the SNS app.

Meanwhile, advertisement content (e.g., “BOY-FRIEND Tweed Watch Small Model”, and the like) posted (or posted) on the profile of the user may be displayed on a bottom of the user profile screen of the SNS app. In addition, various contents (e.g., photos, videos, images, music, related links, and the like) created and posted by the user may be displayed on the bottom of the user profile screen.

A funding button (e.g., a “finger heart” button) may be overlaid on a lower right side of the user profile screen of the SNS app. By clicking the funding button, it is possible to support a corresponding user with an activity fund (i.e., funding or investment), and by supporting with the activity fund, it is possible to be a growth partner (i.e., fan) of the corresponding user. In an embodiment, funding is performed by clicking the funding button on the profile screen of the user, but embodiments are not limited thereto, and as illustrated in FIG. 3B, funding may also be performed by clicking a funding button in the individual content uploaded by the user.

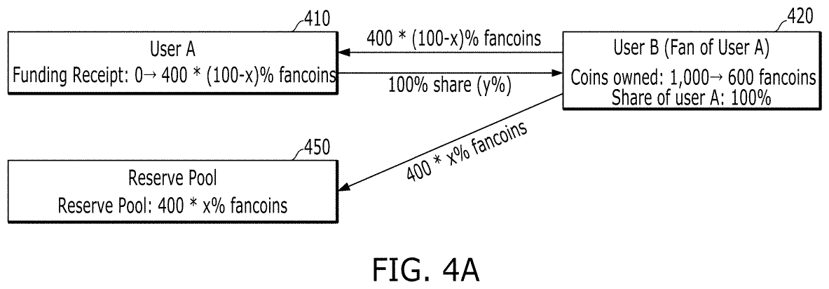

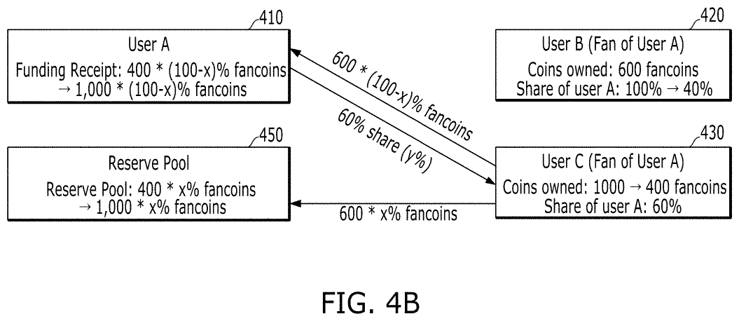

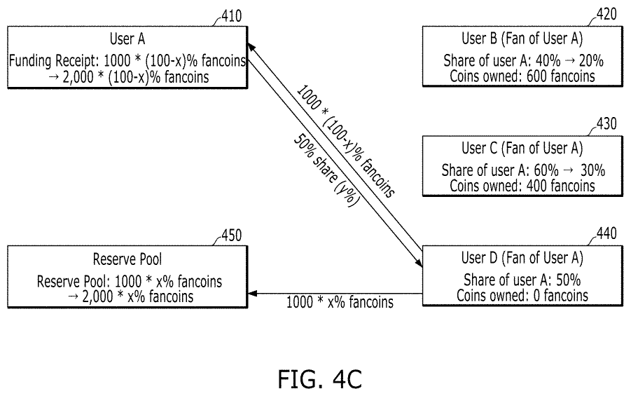

FIGS. 4A to 4C are diagrams illustrating a funding and share acquisition process executed among users in a social networking service according to an embodiment of the present disclosure.

In the present disclosure, the user may become a funding entities, a growth partner, or a fan of another user by clicking the funding button on the profile screen of another user displayed through the SNS app running on the user terminal. In addition, each user may also check the details of the funding received from other users and the details of the funding the user himself or herself funded to other users, in the funding portfolio displayed on his or her own profile screen. Hereinafter, a funding procedure between users in the system according to the present disclosure will be described in detail with reference to the drawings.

As illustrated in FIG. 4A, user B 420 clicks the funding button displayed on the profile screen of user A 410 through an SNS app or clicks the funding button in individual content uploaded by the user A 410 to pay the funding amount. In this case, the remaining amount of the funding amount excluding the reserve rate x of the amount may be paid to the user A as a funding receipt amount. In an embodiment, the reserve rate may be fixedly operated, but is not limited thereto, and may be operated in a flexible form that varies according to other objective indicators.

When the user B 420 pays the funding amount to the user A 410, the user B 420 may acquire a share allocated as a reward for his or her funding activity, with respect to the future activity reward of the user A 410. In this case, the share rate y % may be calculated as a ratio of the funding amount of the user B 420 to the total funding amount received by the user A 410 to date. The share is automatically calculated and applied accordingly, when the total funding amount of the funding target is changed later due to additional funding by other users.

In addition, when the user B 420 pays the funding amount to the user A 410, the amount corresponding to the reserve rate (x) excluded from the funding receipt may be stored and managed in the coin server in the form of a reserve pool 450 for the purpose of activity reward for users. The reserve pool 450 may be paid as the rewards for the activities of SNS users including the user A 410 in the form of indirect activity reward by a predetermined activity reward system. The indirect activity reward is paid from the reserve pool created through funding amount deduction, and the setting of an amount to be paid to the user may be determined based on objective data. For example, the amount may be set based on the quality of the user's content, the number of reactions of other users to the content, and the like.

For example, as illustrated, by funding 400 fancoins to the user A 410, the user B 420 may become a fan of the user A 410. In this case, the user A 410 may obtain the remaining amount, excluding the reserve rate x % from the 400 fancoins as the funding receipt amount, and the user B 420 may calculate the ratio of the funding amount funded by user B 420 to the total funding amount of the user A 410 to acquire a share of distribution corresponding to 100% of the user A 410.

Next, as illustrated in FIG. 4B, another user C 430 may become another fan of the user A 410 by funding 600 fancoins by clicking the funding button displayed on the profile screen of the user A 410 displayed on the SNS app installed on the user terminal, or on the uploaded content. An amount corresponding to the reserve rate x % of the 600 fancoins funded by the user C 430 may be stored as the reserve pool 350.

In this case, the user A 410 obtains an additional funding receipt amount excluding the reserve rate amount from the 600 fancoins, and the funding receipt amount owned by the user A 410 is the amount excluding the reserve amount from 1,000 fancoins. Accordingly, the total funding amount of the user A 410 is changed, and accordingly, the allocation shares of the users who perform funding are automatically calculated again, so that the user C 430 acquires a 60% share of the user A 410, while the ratio of the share owned by user B 420, who was originally the fan of the user A 410, with respect to the user A 410 is changed to 40%.

Next, as illustrated in FIG. 4C, yet another user D 440 may become yet another fan of the user A 410 by funding 1,000 fancoins by clicking the funding button displayed on the profile screen of the user A 410 displayed on the SNS app installed on the user terminal, or on the uploaded content. An amount corresponding to the reserve rate x % of the 1000 fancoins funded by the user D 540 may be stored as the reserve pool 450.

In this case, the user A 410 obtains an additional funding receipt amount excluding the reserve amount from the 1,000 fancoins, and the funding receipt amount owned by the user A 410 is the amount excluding the reserve amount from 2,000 fancoins. Accordingly, the total funding amount of the user A 410 is changed, and accordingly, the allocation shares of the users who performed funding are automatically calculated again, so that the user D 440 acquires a 50% share of the user A 410, while the share rates owned by the user B 420 and the user C 430, who were originally the fans of the user A 410, with respect to the user A 410 are changed to 20% and 30%, respectively.

As described above, as the number of users (funding entities or fans) who fund for a specific user and the funding amount increase or decrease, the share rates owned by the existing funding entities increase or decrease accordingly. In this way, the ratios of the funding (or the share rates) of other users to a specific user may be utilized for distribution of activity revenues, which will be described below.

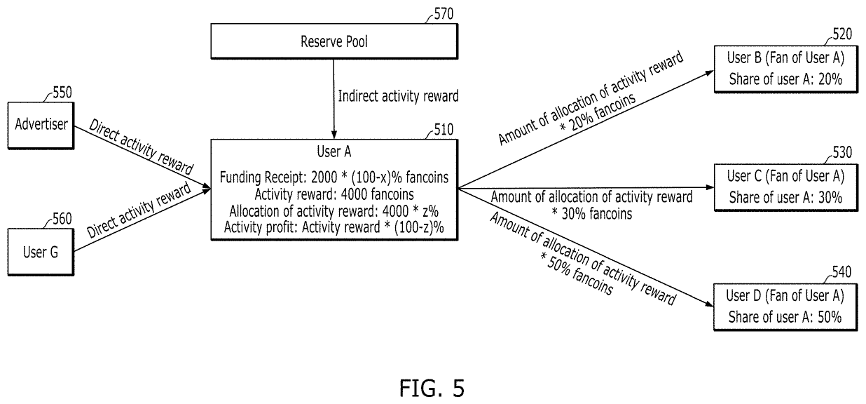

FIG. 5 is a diagram illustrating a procedure of executing activity reward distribution among users in a social networking service according to an embodiment of the present disclosure.

In the present disclosure, the activity reward includes the indirect activity reward by the activity reward system, and the direct activity reward such as product and content sales revenue, advertising fees received from a P2P advertiser 550, or donations from another user 560. In this case, the indirect activity reward may be paid from the reserve pool 570 created through funding amount deduction.

In this disclosure, a specific user may distribute a certain ratio (z %) of the activity reward that increases in proportion to the amount of his or her activity (e.g., creations, transactions, and advertisements of content) according to the funding shares of other users. In an embodiment, the certain ratio (z %) of the activity reward may be fixedly operated, but is not limited thereto, and may be operated in a flexible form. For example, the specific user may maintain 50% of his or her activity reward as his or her activity revenue, and distribute the remaining 50% of his or her activity reward to funding entities according to shares they own.

As illustrated in FIG. 5, the user A 510 may distribute 50% (e.g., 2,000 fancoins) of the activity reward (e.g., 4,000 fancoins) acquired to date to other users B 520, C 530 and D 540 who funded the user A 510 and thus own the shares. That is, the user A 510 may distribute 50% of the activity reward by allocating 400 fancoins, 600 fancoins, and 1,000 fancoins to the user B 520, the user C 530 and the user D 540, respectively in accordance with their 20%, 30%, and 50% shares.

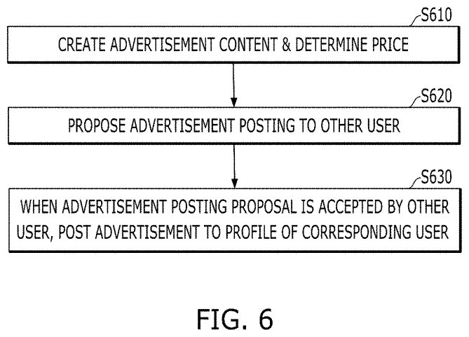

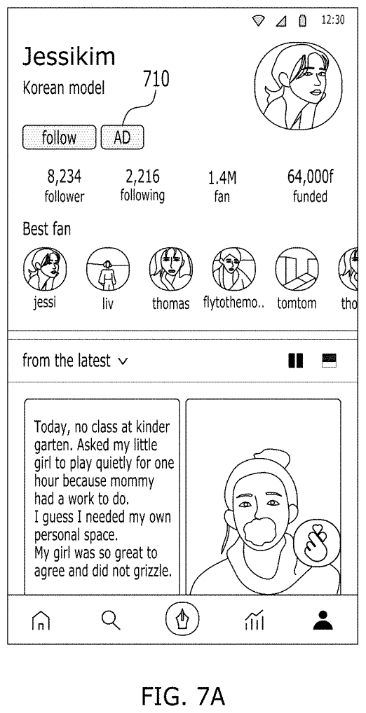

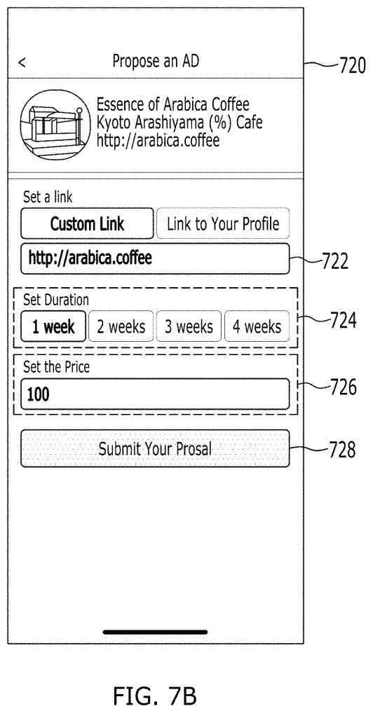

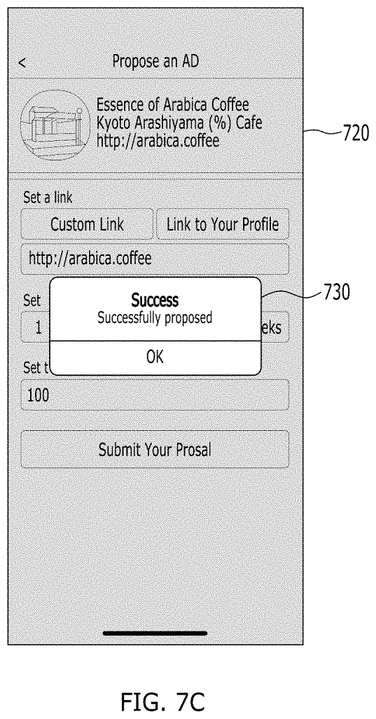

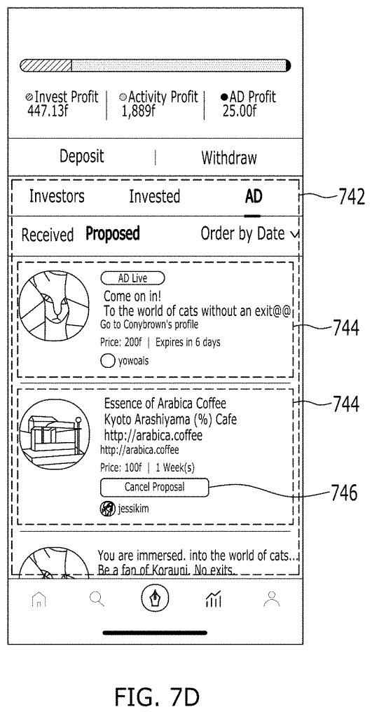

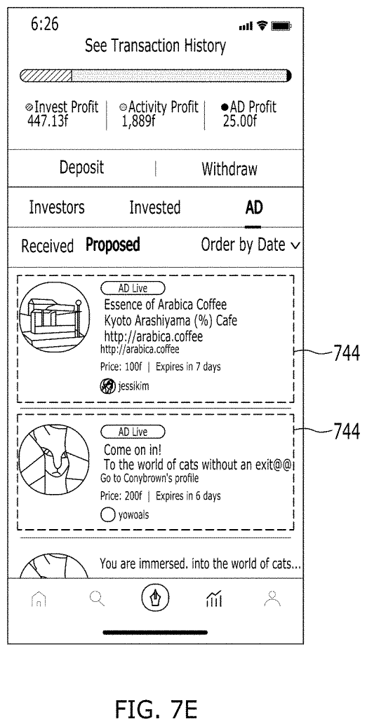

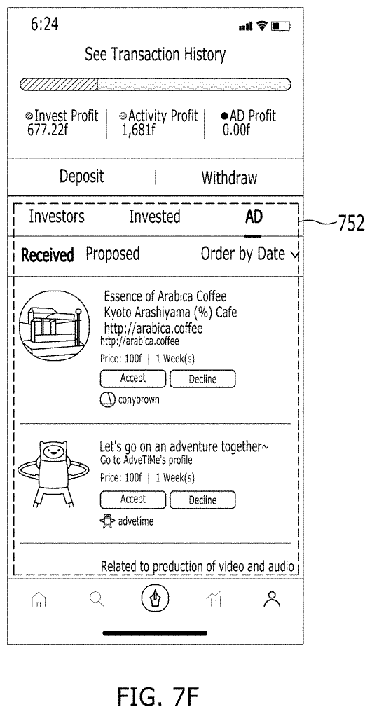

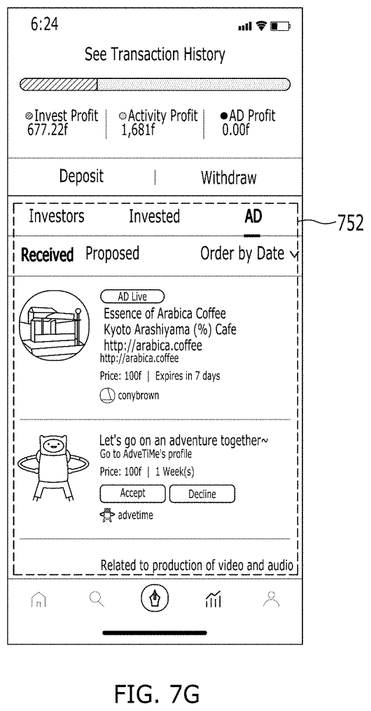

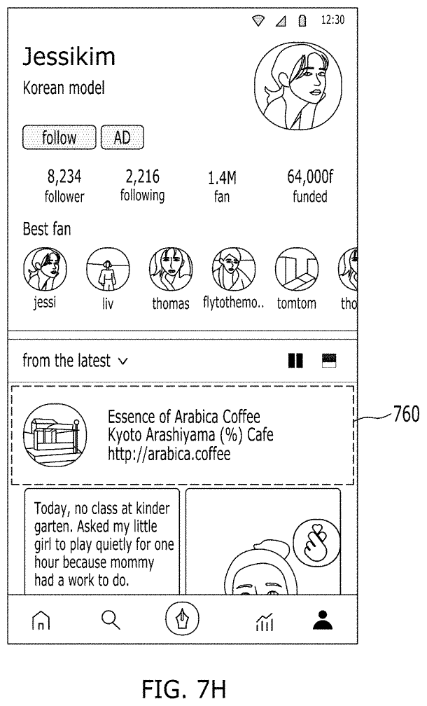

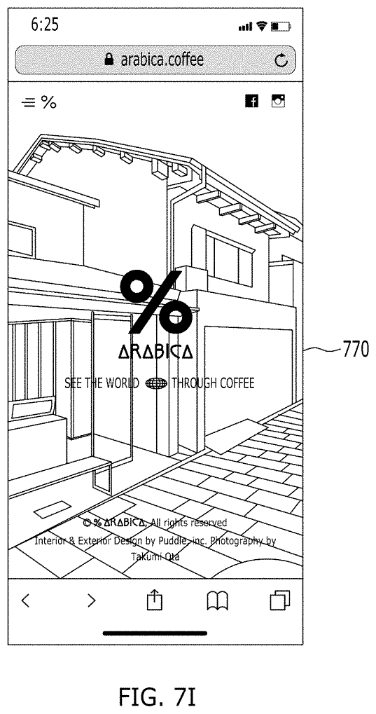

FIG. 6 is a flowchart illustrating a procedure of proposing advertisement postings for a profile of a user and accepting the same in a social networking service according to an embodiment of the present disclosure. FIGS. 7A to 7I are diagrams illustrating a user interface of an application showing a procedure of proposing advertisement postings for a profile of a user and accepting the same in a social networking service according to an embodiment of the present disclosure.

In the SNS app according to the present disclosure, each user may propose an advertisement posting to a user (e.g., “power creator” or “influencer”) who received a lot of funding or created content that is attracting attention, or to a user with many followers. For example, after clicking an advertisement button in a profile of a specific user in the SNS app, it is possible to directly create or upload advertisement content, and propose a price (e.g., the number of coins) for the advertisement. In response, when the specific user accepts the advertisement posting proposal, the advertisement content or related link is posted on the profile of the user, and the proposed price may be accumulated as the advertisement revenue. In this case, when the specific user accepts the advertisement posting proposal, instead of prepaying the price proposed before the advertisement content is posted, the price proposed may be paid after posting of the advertisement content is executed.

At S610, the user may create advertisement content and determine a price. For example, as illustrated in FIG. 7A, the user may click an advertisement button 710 (e.g., “AD”) in the profile of another user (e.g., “Jessikim”) displayed on the screen of the terminal through the SNS app to initiate an advertisement posting proposal 720. As illustrated in FIG. 7B, upon clicking the advertisement button 710 in the profile of the user (“Jessikim”), it is possible to directly create an advertisement content (e.g., to enter “Essence of Arabica Coffee” with related image), to add a link 722 related to the advertisement (e.g., to click a “Custom Link” button and enter “http://arabica.coffee”), to set an advertisement posting period 724 (e.g., to click “1 week” in “Set Duration”), or to set an advertisement price 726 (e.g., to enter “100” coins in “Set the Price”).

At S620, the user may propose to another user to post the created advertisement content. As illustrated in FIG. 7B, when various advertisement conditions are set in the user profile of the user (“Jessikim”) and then an advertisement proposal button 728 (e.g., the “Submit Your Proposal” button) is clicked, the advertisement posting proposal 720 is transmitted to the user of the profile. As illustrated in FIG. 7C, when the advertisement posting proposal 720 is transmitted, a notification window 730 indicating that the advertisement posting proposal 720 has been successfully transmitted may be displayed on the screen of the SNS app (e.g., “Success” is displayed). As illustrated in FIGS. 7D and 7E, the user who proposed the advertisement posting may have a list 742 (e.g., “AD/Proposal” tab) of advertisement postings proposed to date displayed in his or her profile, so that he or she can check conditions 744 of the advertisement postings and whether they are accepted or not. If necessary, the user may cancel the advertisement posting the user himself proposed (e.g., click the “Cancel Proposal” button 746).

At S630, when another user who received the advertisement posting proposal accepts the advertisement posting proposal, the corresponding advertisement is posted on the profile of the user. As illustrated in FIG. 7F, the another user (“Jessikim”) may check a list 752 of advertisement posting proposals transmitted to date in his or her own profile (e.g., click “AD/Received” tab). As illustrated in FIG. 7G, when the another user accepts a specific advertisement posting proposal (e.g., clicks “Accept” button of the advertisement posting proposal displayed on the “AD/Received” cap), the accepted advertisement content or related link 760 is posted on the profile screen of the user (e.g., the “Essence of Arabica Coffee” and related images and links are displayed) as illustrated in FIG. 7H. When the another user clicks on the posted advertisement content or related link on the profile of the user (“Jessikim”), an advertisement page 770 (e.g., “arabica.coffee”) connected to the link may be displayed on the screen of the SNS app as illustrated in FIG. 7I.

In the embodiment described above, it has been described that the content, period, and price of the advertisement are set at S610, but the content of the advertisement posting proposal is not limited thereto. The user may also select and propose one of various methods of adding advertisement fees to the profile owner. For example, a method may be proposed, which includes, when the advertisement content or advertisement link posted on a profile of a specific user is clicked, additionally adding the advertisement fee to the user who created the clicked advertisement. As such a method for adding the advertisement fee, any one of various methods such as cost per click (CPC), cost per action (CPA), cost per install (CPI), cost per engagement (CPE), cost per sale (CPS), cost per mille (CPM), cost per time (CPT), and the like, may be used.

In an embodiment, two or more methods of adding the advertisement fee for advertisement content or advertisement link may be applied in duplicate. For example, when the method for adding the advertisement fee to the advertisement content or advertisement link posted on the profile of the specific user is CPM, the advertisement may be ended midway when the CPC method of the same standard is exceeded. By applying, in duplicate, the CPM fee addition method in which the posted advertisement content or advertisement link is exposed 1,000 times, and the CPC fee addition method in which the advertisement content or advertisement link is clicked 1,000 times, even when the advertisement exposure does not reach 1,000 times, the advertisement posting may be ended when 1,000 clicks are achieved.

The techniques described herein may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design constraints imposed on the particular application and the overall system. Those skilled in the art may implement the described functions in varying ways for each particular application, but such decisions for implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or a combination thereof.

Accordingly, various example logic blocks, modules, and circuits described in connection with the disclosure herein may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of such configurations.

In the implementation using firmware and/or software, the techniques may be implemented with instructions stored on a computer readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described herein.

When implemented in software, the functions may be stored on a computer readable medium as one or more instructions or codes, or may be transmitted through a computer readable medium. The computer-readable media include both the computer storage media and the communication media including any medium that facilitates the transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. Also, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be coupled to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

The above description of the present disclosure is provided to enable those skilled in the art to make or use the present disclosure. Various modifications of the present disclosure will be readily apparent to those skilled in the art, and the general principles defined herein may be applied to various modifications without departing from the spirit or scope of the present disclosure. Accordingly, the present disclosure is not intended to be limited to the examples described herein, but is intended to be given the broadest scope consistent with the principles and novel features disclosed herein.

Although example implementations may refer to utilizing aspects of the presently disclosed subject matter in the context of one or more standalone computer systems, the subject matter is not so limited, and they may be implemented in conjunction with any computing environment, such as a network or distributed computing environment. Furthermore, aspects of the presently disclosed subject matter may be implemented in or across a plurality of processing chips or devices, and storage may be similarly influenced across a plurality of devices. Such devices may include PCs, network servers, and handheld devices.

Although the subject matter has been described in language specific to structural features and/or methodological acts, it will be understood that the subject matter defined in the appended claims is not necessarily limited to the specific features or acts described above. Rather, the specific features and acts described above are described as example forms of implementing the claims.

Although the method mentioned herein has been described through specific embodiments, it is possible to implement it as computer readable code on a computer readable recording medium. The computer readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

Although the present disclosure has been described in connection with some embodiments herein, it should be understood that various modifications and changes can be made without departing from the scope of the present disclosure, which can be understood by those skilled in the art to which the present invention pertains. Further, such modifications and changes are intended to fall within the scope of the claims appended herein.

What is claimed is:

1. A method for executing activity reward and advertisement transactions in a social networking service, comprising:
transmitting, by a terminal of a first user, at least a portion of coins owned by the first user to a terminal of a second user as a funding amount for acquiring a share of the second user;
providing, by the terminal of the second user, the share to the first user according to a ratio of the funding amount transmitted by the first user with respect to a total funding amount received by the second user; and
providing, by the terminal of the second user, at least a portion of activity reward given to the second user according to a share rate owned by the first user with respect to the second user.

2. The method according to claim 1, further comprising:
calculating, by a coin server, a reserve rate of the funding amount to prepare a reserve pool for payment of activity reward for users of the social networking service; and
calculating, by the coin server, a share rate which is a ratio of the funding amount transmitted by the first user with respect to the total funding amount received by the second user.

3. The method according to claim 1, further comprising directly setting, by a coin server, at least a portion of the activity reward given to the second user as an activity reward according to a share rate owned by the first user with respect to the second user.

4. The method according to claim 3, further comprising setting, by the coin server, an indirect activity reward in a reserve pool to be paid for activities of users of the social networking service according to a predetermined activity reward system.

5. A system for executing activity reward and advertisement transactions in a social networking service, comprising:
a reserve rate calculation unit that calculates a reserve rate of a funding amount exchanged between users of the social networking service to prepare a reserve pool for a payment of activity reward of users of the social networking service;
a share rate calculation unit that calculates a share rate which is a ratio of the funding amount transmitted by other users with respect to a total funding amount funded to one of the users; and
a reward setting unit that sets the activity reward according to the share rate or the activities of the users.

6. The system according to claim 5, wherein the reward setting unit directly sets at least a portion of the activity reward given to a second user of the users as an activity reward according to a share rate owned by a first user with respect to the second user.

7. The system according to claim 5, wherein the reward setting unit sets an indirect activity reward to be paid for the activities of the users from the reserve pool according to a predetermined activity reward system.

8. The system according to claim 5, further comprising a database for storing and managing the reserve rate, the share rate, and the activity reward.

9. The system according to claim 8, wherein the reserve pool, the funding amount, and the activity reward are implemented in Ethereum-based blockchain cryptocurrency or electronic form of cryptocurrency.

10. A method for executing activity reward and advertisement transactions in a social networking service, comprising:
creating, by a terminal of a first user, advertisement content;
presenting, by the terminal of the first user, an advertisement posting proposal and an advertisement price through a profile of a second user;
determining, by a terminal of a second user, whether or not to accept the advertisement content and the advertisement price proposed by the first user;
paying, by the terminal of the first user, the proposed price to the terminal of the second user when the advertisement content and the advertisement price are accepted by the terminal of the second user; and
posting, by the terminal of the first user, the advertisement content through a profile of the first user.
